(19) United States
(12) Patent Application Publication
(10) Pub. No.: US 2003/0144060 A1
(43) Pub. Date: Jul. 31, 2003

(54) Convoluted boot assembly with protective cap

(76) Inventors: Heinzwilli Fuchs, Muhleip (DE); Karl-Heinz Hulsebusch, Koln (DE); Werner Krude, Neunkirchen-Seelscheid (DE); Karl-Heinz Muller, Wissen (DE); Colin Zaers, Siegburg (DE)

Correspondence Address: Robert P. Renke, Suite 250, 28333 Telegraph Road, Southfield, MI, 48034, US

(21) Appl. No.: 10/318,878

(22) Filed: Dec. 13, 2002

(30) Foreign Application Priority Data
Dec. 14, 2001 (DE) 101 61 491.8

(51) Int. Cl. F16D 3/84; F16C 1/26

(52) U.S. Cl. 464/175

(57) ABSTRACT

A convoluted boot assembly particularly suited for sealing a sideshaft connected to a constant velocity joint and arranged at the axle drive of a motor vehicle, relative to the housing of the axle drive. The convoluted boot assembly includes a convoluted boot (21) which includes a first collar (22) to be secured relative to the shaft (41), a second collar (23) to be connected to the housing (51) and a boot region (24) which connects the two collars (22, 23) and serves to offset the angular movements of the shaft. The assembly also includes a protective cap (31) which is secured to the first collar (22) and which encloses the boot region (24) of the convoluted boot (21) at least substantially in the direction pointing to the second collar (23), and a bearing assembly (11) for supporting the convoluted boot (21) on the shaft (41), as well as a seal (16) for sealing the first collar (22) relative to the shaft (41).

### TECHNICAL FIELD

The invention relates to a convoluted boot assembly for sealing a rotating shaft relative to a housing from which there emerges the shaft, and, in particular, for sealing a side shaft connected to a constant velocity joint and arranged at the axle drive of a motor vehicle, relative to the housing of the axle drive. Convoluted boot assemblies of this type prevent dirt from entering the housing, and lubricant from leaving the housing.

### BACKGROUND OF THE INVENTION

There are prior art stationary convoluted boot assemblies of the foregoing type wherein the first collar is rotatably supported on the shaft, with the second collar being sealingly secured to the housing aperture.

In general, as a result of constant flexing, convoluted boots are subjected to very high loads when the shaft is articulated. Furthermore, convoluted boots are subject to external mechanical influences such as the impact generated by stones. If the convoluted boot fails, the lubricant runs out of the housing and the drive contained in the housing runs dry.

### SUMMARY OF THE INVENTION

It is therefore an object of the present invention to provide a convoluted boot assembly for sealing a rotating shaft relative to a housing which provides more advantageous load spectra and thus a longer service life.

A first solution provides a convoluted boot assembly for sealing a rotating shaft relative to a housing. The assembly comprises a convoluted boot which comprises a first collar to be secured relative to the shaft, a second collar to be connected to the housing and a boot region connecting the two collars. The assembly also includes a protective cap having a holding collar which is secured to the first collar and having an annular shell which encloses the boot region of the convoluted boot in the direction pointing to the second collar, a bearing on to which the first collar is slid, for rotatably supporting the convoluted boot with respect to the shaft, as well as a seal for sealing the first collar relative to the shaft.

A second solution provides a convoluted boot assembly for sealing a rotating shaft relative to a housing. The assembly comprises a convoluted boot which comprises a first collar to be secured relative to the shaft, a second collar to be connected to the housing and a boot region connecting the two collars and serving to balance the movements of the shaft relative to the housing. The assembly also includes a bearing assembly for rotatably supporting the convoluted boot with respect to the shaft, a protective cap having a holding collar which is secured to the bearing assembly and having an annular shell which encloses the boot region of the convoluted boot in the direction pointing toward the second collar and to whose inside the first collar is connected, as well a seal for sealing the holding collar relative to the shaft.

The present convoluted boot assembly is advantageous in that it can be firmly connected to a stationary housing and supported on the shaft. In this way, it is ensured that the convoluted boot assembly is stationary relative to the rotating shaft and carries out only articulation movements and, optionally, plunging movements. The degree of flexing is therefore very small, which means that material with a greater stiffness value can also be used. The protective cap ensures that the convoluted boot is effectively protected against external influences such as the impact generated by stones or such. The load spectra for the convoluted boot assembly is thus improved, as is the service life of the convoluted boot assembly.

According to one embodiment of the invention based on the first solution, the bearing assembly and the seal form a bearing/sealing unit which comprises an outer race carrying the first collar of the convoluted boot, an inner race to be secured to the shaft, rolling-contact members, a cage for holding the rolling-contact members and a radial shaft sealing ring. As a result of this integral design, the assembly procedures for slipping the bearing/sealing unit on to the shaft on the one hand, and for securing the convoluted boot on the bearing/sealing unit on the other hand, are reduced to a minimum.

In another embodiment, the protective cap is connected to the first collar of the convoluted boot in a form-fitting or material-locking way. For a material-locking connection, the first collar is provided in the form of a wall part which rests against the inside of the annular shell and is glued or vulcanised on to same. On the other hand, a form-fitting connection between the protective cap and the convoluted boot can be achieved, for example, by crimping the annular shell of the protective cap around the annular-bead-shaped first collar of the convoluted boot.

According to a further embodiment, the protective cap comprises a holding collar which is formed to be integral with the outer race of the bearing/sealing unit.

According to another embodiment of both above-mentioned solutions, in the region adjoining the cylindrical holding collar in the direction pointing to the second collar, the protective cap is designed to widen spherically on its outside. The protective cap thus extends substantially, or even entirely, over the convoluted boot at a distance from the boot region and from the second collar and protects same against damage of any kind, even when the shaft carries out angular movements relative to the housing. The protective cap is preferably formed of a metallic material, such as aluminium. Furthermore, the convoluted boot can comprise a thermoplastic elastomer (TPE) or rubber.

Other advantages and features of the invention will also become apparent upon reading the following detailed description and appended claims, and upon reference to the accompanying drawings.

### BRIEF DESCRIPTION OF THE DRAWINGS

For a more complete understanding of this invention, reference should now be made to the embodiment illustrated in greater detail in the accompanying drawings and described below by way of examples of the invention.

In the drawings:

FIG. 1 shows an inventive convoluted boot assembly according to a first solution prior to assembly and including a shaft.

FIG. 2 shows the convoluted boot assembly according to FIG. 1 with a shaft in the assembled condition.

FIG. 3 shows the combination of convoluted boot assembly and shaft according to FIG. 2, mounted to a housing.

FIG. 4 shows the combination of an inventive convoluted boot assembly according to a second solution and having a shaft, mounted to a housing.

### DETAILED DESCRIPTION OF THE INVENTION

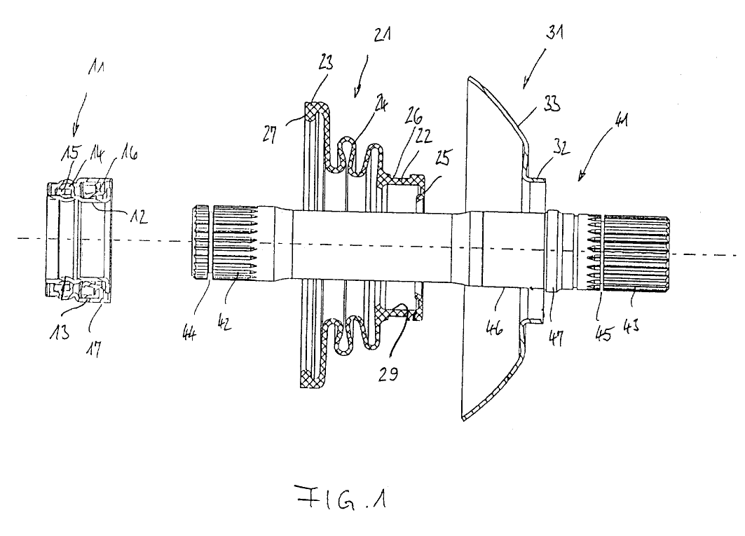

FIG. 1 shows a rolling contact bearing assembly 11, a convoluted boot 21 and a protective cap 31 as parts of a convoluted boot assembly prior to being assembled. A shaft 41 can be combined with the above-mentioned parts to form a shaft sealing assembly. At its ends, the shaft 41 comprises two shaft toothing portions 42, 43 with annular grooves 44, 45, respectively, which each engage an axial securing mechanism. Furthermore, the shaft 41 comprises a cylindrical bearing seat region 46 whose diameter is greater than or equal to the diameter of the shaft toothing 42, 43. The shaft 41 also includes a collar 47 with a greater diameter which delimits the bearing seat region 46 at the end of the shaft toothing 43.

The bearing assembly 11 is arranged so as to extend coaxially relative to the shaft 41 and at an axial distance from the shaft toothing 42. The bearing assembly 11 comprises an inner race 12 made of plate metal and an outer race 13 made of plate metal, which inner race 12 and outer race 13 form ball grooves for the bearing balls 14. The bearing balls 14 are held together by a ball cage 15. Furthermore, between the inner plate metal race 12 and the outer plate metal race 13 there is arranged a multi-part shaft sealing ring 16 which is fixed, relative to the outer race 13. Outside the shaft sealing ring 16, the outer race 13 forms a convoluted boot seat 17. The above-mentioned parts form a bearing/sealing assembly 11. The inner diameter of the inner race 12 is dimensioned in such a way that the bearing assembly can be slid over the shaft toothing 42 and secured to the bearing seat 46 by means of a press fit, with the bearing assembly abutting the collar 47 for axial fixing purposes.

The convoluted boot 21 is shown in a position where it extends coaxially relative to the shaft 41 while already being partially slid on to same. The convoluted boot 21 is shown to comprise a smaller collar 22, a larger collar 23 and a folded region 24. Inside the small collar 22, towards the outside, there is formed a sealing lip 25. In the smaller collar 22 there is provided an outer annular groove 26 and an inner annular groove 29. On the inside of the larger collar 23 there is formed on all annular bead 27. The convoluted boot 21 can be slipped on to the convoluted boot seat 17 of the bearing assembly by means of its smaller collar 22, with this operation preferably taking place before the bearing assembly 11 is mounted on the shaft 41.

At an axial distance from the convoluted boot 21 and coaxially relative to the shaft 31, there is shown a protective cap 31 which is in its axial design position and which is shown to comprise a holding collar 32 for the small collar 22 of the convoluted boot and an annular shell member 33 for protecting the convoluted boot 21. After the convoluted boot 21 and the bearing assembly 11 have been assembled, the protective cap is slipped on the small collar 22 by means of its holding collar 32, with the holding collar 32 engaging the outer annular groove 26 and with the bearing assembly 11 engaging the inner annular groove 29 of the small collar. The sealing lip 25 in the form of additional protecting means is positioned in front of the shaft sealing ring 16. The protective cap 31 holds the convoluted boot with pretension on the convoluted boot seat 17. For this purpose, the holding collar 32 which is initially positioned with a transition fit or play fit is radially reduced by plastic deformation, so that, subsequently, with a press fit, it holds the small collar 22 on the convoluted boot seat 17. This operation, too, preferably takes place before the bearing assembly 11 is mounted on the shaft 41. In a region adjoining the holding collar 32, in the direction pointing toward the second collar 23, the protective cap 31 is spherical.

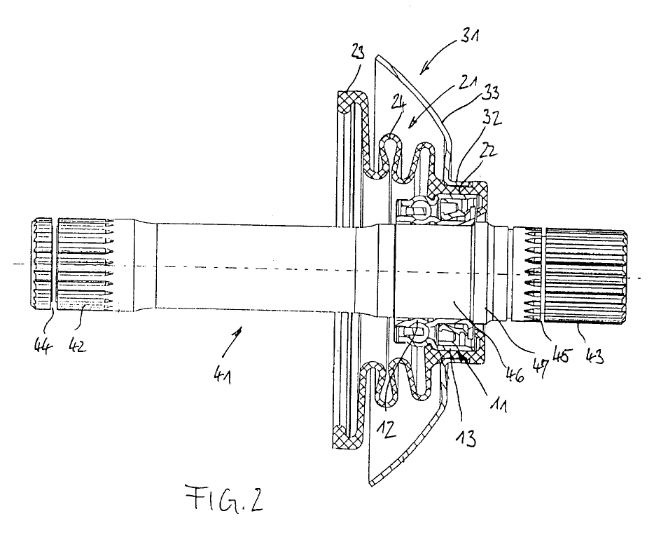

FIG. 2 shows the result of the above-described assembly sequence of a shaft sealing assembly consisting of a convoluted boot assembly and a shaft. Identical details have been given the same reference numbers as those used in FIG. 1. To that extent, reference is made to the description of same. The bearing assembly 11, by means of its inner race 12, is positioned with a press fit on the bearing seat 46 of the shaft 41 and rests against the collar 47. The small collar 22 of the convoluted boot is slipped on to the convoluted boot seat 17 of the outer race 13. In the annular groove 26 of the small collar 22, there is positioned, with pretension, the holding collar 32 of the protective cap 31. The assembly is ready to be inserted into a housing inside which there is arranged a component with counter toothing relative to the shaft toothing 42 of the shaft 41. Subsequently, for sealing purposes, the large collar of the convoluted boot 21 has to be secured to the housing.

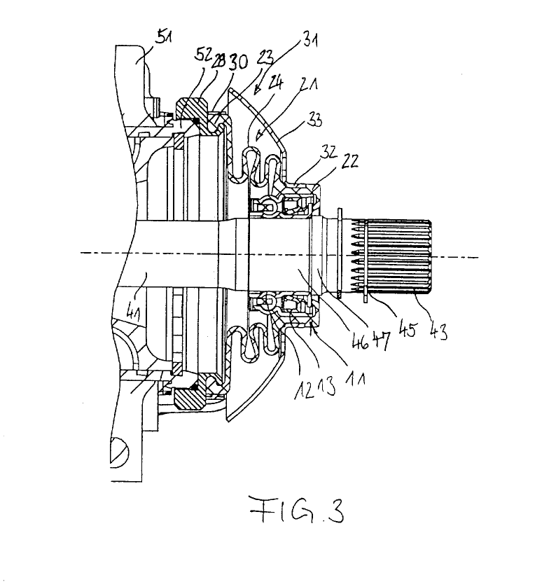

FIG. 3 shows the assembly according to FIG. 2 in a fully mounted configuration at a housing. Identical details have been given the same reference numbers as those used in FIG. 2. To that extent, reference is made to the description of same. The large collar 23 of the convoluted boot is tensioned by a tensioning strip 30 on a profiled carrier ring 28. The tensioning can take place before or after the profiled carrier ring 28 has been pressed on to an annular projection 52 at the housing 51.

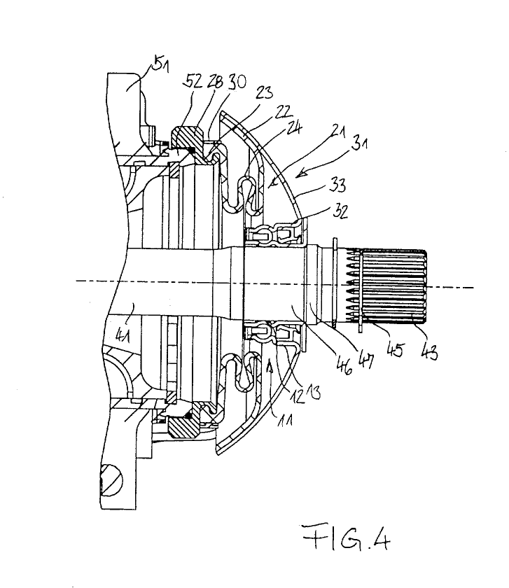

FIG. 4 shows a shaft sealing assembly consisting of a convoluted boot assembly and a shaft. Identical details have been given the same reference numbers as those used in FIG. 3. To that extent, reference is made to the description of same. By means of its inner race 12, the bearing assembly 11 is arranged, by a press fit, on the bearing seat 46 of the shaft 41 and rests against the collar 47. The outer race 13 is produced so as to be integral with the holding collar 32 of the protective cap 31. The first collar 22 of the convoluted boot 21 extends outwardly in the form of a wall part and is secured to the inside of the annular shell 33 of the protective cap so as to rest thereagainst in a planar way. The second collar 23 of the convoluted boot 21 is tensioned by a tensioning strip 30 on a profiled carrier ring 28 which, in turn, is pressed on to an annular projection 52 at the housing 51.

The inventive assembly provides a largely pre-produced sealing mechanism which is easy to mount between a rotating shaft and a stationary housing in which the convoluted boot does not rotate. It is thus subjected to low loads only and, in addition, is largely protected by the protective cap against mechanical damage. In particular, the invention includes the use of such assemblies in the sideshafts of an axle drive with integrated constant velocity universal joints. While the invention has been described in connection with one or more embodiments, it should be understood that the invention is not limited to those embodiments. Thus, the invention covers all alternatives, modifications, and equivalents as may be included in the spirit and scope of the appended claims.

What is claimed is:

1. A convoluted boot assembly for sealing a rotating shaft (41) relative to a housing (51) from which there emerges the shaft (41), comprising:
a convoluted boot (21) comprising a first collar (22) to be secured relative to the shaft (41), a second collar (23) to be connected to the housing (51) and a boot region (24) connecting the two collars (22, 23);
a protective cap (31) having a holding collar (32) which is secured to the first collar (22) and having an annular shell (33) which encloses the boot region (24) of the convoluted boot (15) in the direction pointing toward the second collar (23);
a bearing assembly (11) on to which the first collar (22) is slid, for rotatably supporting the convoluted boot (21) with respect to the shaft (41); and
a seal (16) for sealing the first collar (22) relative to the shaft (41).

2. A convoluted boot assembly for sealing a rotating shaft (41) relative to a housing (51) from which there emerges the shaft (41), comprising:
a convoluted boot (21) comprising a first collar (22) to be secured relative to the shaft (41), a second collar (23) to be connected to the housing (51) and a boot region (24) connecting the two collars (22, 23);
a bearing assembly (11) for rotatably supporting the convoluted boot (21) with respect to the shaft (41);
a protective cap (31) having a holding collar (32) which is secured to the bearing assembly (11) and having an annular shell (33) which encloses the boot region (24) of the convoluted boot (15) in the direction pointing toward the second collar (23) and to whose inside the first collar (22) is connected; and
a seal (16) for sealing the holding collar (32) relative to the shaft (41).

3. A convoluted boot assembly according to claim 1, wherein the bearing assembly (11) and the seal (16) form a bearing/sealing unit which comprises an outer race (13) carrying the first collar (22) of the convoluted boot (21), an inner race (12) to be secured to the shaft (41), rolling-contact members (14), a cage (15) for holding the rolling-contact members (14), and a radial shaft sealing ring (16).

4. A convoluted boot assembly according to claim 2, wherein the bearing assembly (11) and the seal (16) form a bearing/sealing unit which comprises an outer race (13) carrying the holding collar (32) of the protective cap (31), an inner race (12) to be secured to the shaft (41), rolling-contact members (14), a cage (15) for holding the rolling contact members (14) and a radial shaft sealing ring (16).

5. A convoluted boot assembly according to claim 1, wherein the protective cap (31) is connected to the first collar (22) of the convoluted boot (21) in a force-locking or material-locking way.

6. A convoluted boot assembly according to claim 2, wherein the protective cap (31) is connected to the first collar (22) of the convoluted boot (21) in a force-locking or material-locking way.

7. A convoluted boot assembly according to claim 1, wherein the first collar (22) of the convoluted boot (21) is connected to the bearing assembly (11) in a force-locking or material-locking way.

8. A convoluted boot assembly according to claim 3, wherein the first collar (22) of the convoluted boot (21) is connected to the bearing assembly (11) in a force-locking or material-locking way.

9. A convoluted boot assembly according to claim 1, wherein the protective cap (31) comprises a holding collar (32) which, with pre-tension, engages an annular groove (26) extending around the outside of the first collar (22).

10. A convoluted boot assembly according to claim 3, wherein the protective cap (31) comprises a holding collar (32) which, with pre-tension, engages an annular groove (26) extending around the outside of the first collar (22).

11. A convoluted boot assembly according to claim 2, wherein the first collar (22) of the convoluted boot (21) is formed by a wall part resting against the annular shell (33).

12. A convoluted boot assembly according to claim 4, wherein the first collar (22) of the convoluted boot (21) is formed by a wall part resting against the annular shell (33).

13. A convoluted boot assembly according to claim 2, wherein the protective cap (31) comprises a holding collar (32) which is formed to be integral with an outer race (13) of the bearing assembly (11).

14. A convoluted boot assembly according to claim 4, wherein the protective cap (31) comprises a holding collar (32) which is formed to be integral with the outer race (13) of the bearing assembly (11).

15. A convoluted boot assembly according to claim 1, wherein in a region adjoining the holding collar (32), in the direction pointing toward the second collar (23), the protective cap (31) is spherical.

16. A convoluted boot assembly according to claim 2, wherein in a region adjoining the holding collar (32), in the direction pointing toward the second collar (23), the protective cap (31) is spherical.

17. A convoluted boot assembly according to claim 1, wherein the protective cap (31) is metal.

18. A convoluted boot assembly according to claim 2, wherein the protective cap (31) is metal.

19. A convoluted boot assembly according to claim 1, wherein the protective cap (31) is secured to the first collar (22) by radially deforming the holding collar (32).

20. A convoluted boot assembly according to claim 3, wherein the protective cap (31) is secured to the first collar (22) by radially deforming the holding collar (32).

21. A convoluted boot assembly according to claim 1, wherein the convoluted boot (15) comprises a thermoplastic elastomer (TPE) or rubber.

22. A convoluted boot assembly according to claim 2, wherein the convoluted boot (15) comprises a thermoplastic elastomer (TPE) or rubber.

23. A convoluted boot assembly according to claim 1, wherein the second collar (23) is positioned on a profiled ring (28) which is connectable to the housing (51).

24. A convoluted boot assembly according to claim 2, wherein the second collar (23) is positioned on a profiled ring (28) which is connectable to the housing (51).
